(19) United States
(12) Patent Application Publication
(10) Pub. No.: US 2006/0054043 A1
(43) Pub. Date: Mar. 16, 2006

(54) Item with forgery-proof printing

(76) Inventor: Markus Luthi, Marthalen (CH)

Correspondence Address: FISHER, CHRISTEN & SABOL, 1725 K STREET, N.W., SUITE 1108, WASHINGTON, DC, 20006, US

(21) Appl. No.: 11/220,607

(22) Filed: Sep. 8, 2005

(30) Foreign Application Priority Data
Sep. 9, 2004 (EP) 04405561.4

(51) Int. Cl. B41F 33/00

(52) U.S. Cl. 101/483

(57) ABSTRACT

In order to increase the degree of proof against forgery, an item (10) with forgery-proof printing on at least one surface area (12) featuring a first printed image (14) is printed over on the first image (14) by a second image (16) which is of a transparent, matt lacquer and exhibits a higher resolution than that of the first image (14). An existing printed pattern or design can be printed using the printing method used to date. The second image is printed over this first image as a security measure, this without altering the optical appearance of the first printed image.

The invention relates to an item bearing forgery-proof printing having at least one surface area with a first printed image and relates also to a process for improving the degree of proof against forgery of an item's surface printed with a first image.

Forgery-proof packaging is of great importance especially in the pharmaceutical industry. However, in other branches of industry there is also need for forgery-proof packaging or products, especially in the consumer goods industry e.g. in the packaging of foodstuffs, cosmetic items, clothes, software and music CD's or bonds. The item with the printed first image may be a form of packaging, packing, packing aid or a product itself featuring on one surface a security feature e.g. a label with printed image thereon.

Forgery-proof packaging or packing aid can serve as a guarantee of origin which enables the customer to recognise that the product purchased really has been manufactured and packaged by the desired producer. A forgery-proof packaging aid may in some cases also be used as a guarantee of first opening e.g. in the form of a label, a revenue stamp or sealing strip etc. which e.g. are attached over a bottle cap or over a closure on a wide-necked glass, over a seam between a lid and a container or over the tear-opening strip of a pouch. On opening the packaging in question, if the label, revenue stamp or sealing strip has been destroyed, this indicates that the packaging or container has already been opened. It is also possible to repack the items in or enclose them in additional packaging which bears characteristic features that cannot be copied and indicate that the repacking has been carried out by a particular supplier.

Known forgery-proof packaging and products are provided with holograms or exhibit colour coding or invisible features. In practice holograms have proved to offer a high degree of proof against forgery. Examples thereof are e.g. hologram labels or lid films with integral holograms. The production of holograms, however, involves enormous expense.

Known from EP-A-0 967 091 is an item featuring a surface that creates an optical effect for the purpose of increasing the degree of proof against forgery. The surface area with the optical effect exhibits at least two image patterns that are spaced a given distance apart by means of a layer of transparent material; on changing the angle of observation, the optical perception of the of the overall image changes as a result of the superposition of the image patterns. The distance between the images, defined by the thickness of the layer of material, is chosen such that the images produce Moire interference effects.

The object of the invention is to provide in a simple manner an item that already bears an image with a greater degree of proof against forgery.

That objective is achieved by way of the invention in that, in order to increase the degree of proof against forgery, a second image of a transparent, matt lacquer and higher resolution than that of the first image is printed over the first image.

The essential aspect of the invention is that an existing image or design can be printed using the printing method employed to date and the second printed image is printed on top of the first image as a security measure, this without altering the optical appearance of the first image. Shifting the security image into another plane has the advantage that the existing first image can be printed in the manner employed to date and need not be conceived as a security measure. The transparent matt lacquer employed for the second image is preferably colourless. The second printed image exhibits e.g. a complex pattern.

The printing of the second i.e. security image requires a special printing method that produces high resolution. These systems, normally only for security type images and not for normal printing, are expensive and are often not readily available with the result that the improved forgery proofing is due to the limited availability of these expensive systems. Among the printing methods that are suitable for depositing the second printed image are e.g. intaglio (gravure) printing with very high resolution printing cylinders as is known from various etching methods and transcribe-gravure, or an offset printing method.

The item according to the invention may e.g. be any packaging material in the form of a packing material or aid to packing. The packing may be rigid, semi-rigid or flexible and may be in the form of a shaped body or, in particular, may be a film-shaped material. Examples of shaped bodies are blown, deep-drawn and/or stretched or deepened shaped bodies such as bottles, wide-necked containers, beakers, dishes or base parts of push-through or blister packs. Examples of film-type materials are metal foils such as aluminium, steel silver or gold foils. Other examples of film-type materials are papers such as tissue paper of having a weight per unit area of 20 to 30 g/m² or high-grade white paper of 40 to 60 g/m², cardboard, semi-cardboard or the like. Important are in particular films containing plastic e.g. on the basis of polyolefins such as polyethylenes or polypropylenes, polyamides, polyvinylchloride, polyesters such as polyalkylene-terephthalates and in particular polyethylene-terephthalate. The plastic films may be monofilms of plastics, laminates made up of two or more plastic films, laminates of metal foils and plastic films or laminates of papers and metal foils and plastic films. The individual plastic films may have a thickness e.g. of 12 to 200 μm and the metal foils a thickness of 12 to 100 μm. Preferred plastic films are non-oriented or axial or biaxial oriented films on the basis of polyolefins, such as polyethylenes or polypropylenes, polyamides, polyvinyl-chloride, polyesters, such as polyalkylene-terephthalates and in particular polyethylene-terephthalate.

The above mentioned packaging materials may form the items according to the invention in the form of packing materials or aids to packing. For example, sealing pouches, sachets, wraps, bags etc. may be made by punching these out from the film-type packing material. Using deep drawing and/or stretch drawing films may be shaped into the form of shaped bodies, such as base parts for push-through packs or blister packs or wide-necked containers, menu dishes, goblets, beakers etc. Also e.g. tubes (laminate type tubes) or lids for shaped forms of packaging may be made from the films. Also boxes such as foldable boxes can be made e.g. from substrates containing cardboard. It is also possible to employ as substrates bottles from blown plastics or pre-formed packaging. Closures, openings, seams, seams between a base part and the associated lid etc. may be provided with an aid to packing according to the invention in the form of a label, sealing strip, revenue stamp, a seal of guarantee, or a covering. These last mentioned aids to packing are normally present in the form of films and are attached to the container over the opening and on neighbouring parts of the container e.g. by means of adhesion, welding, flanging or shrink-fit.

Apart from the above mentioned use of the item according to the invention in the form of packing, packing material or an aid to packing a further field of application lies in the forgery-proof production of bonds, entry tickets and such documents.

Further advantages, features and details of the invention are revealed in the following description of preferred exemplified embodiments and with the aid of the drawing which shows schematically in:

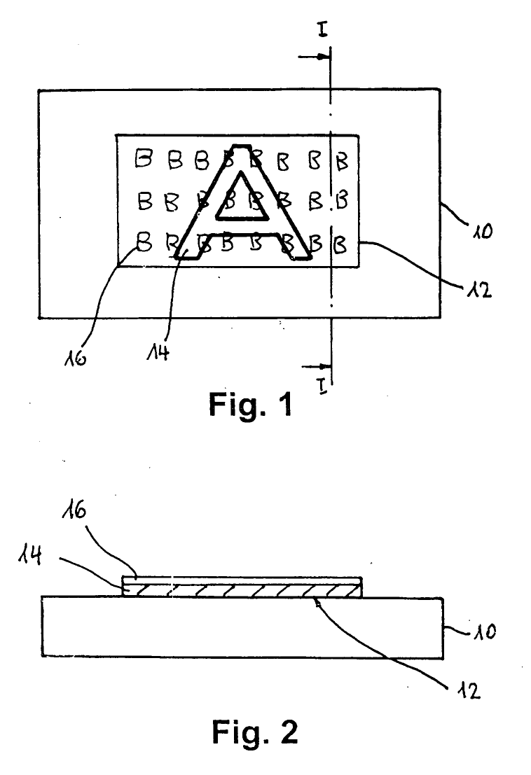

FIG. 1 plan view of a printed item;

FIG. 2 a cross-section through the item shown in FIG. 1 along line I-I.

The item 10 shown in FIGS. 1 and 2 exhibits a surface area 12 on which the first image 14 has been printed. Printed on top of this first image 14 is a second image 16 which has been printed using a transparent, colourless matt lacquer. By using a transparent, colourless matt lacquer for the second image 16 the first image 14 remains visible without any limitations.

The item 10 is for example the lid foil of a blister pack for medicaments. The first printed image 14 is made up e.g. of details required of medicaments by law i.e. name of the product, manufacturer, amount of active ingredient etc. The second printed image 16 is deposited as a security feature with high resolution and comprises e.g. a complex design made up of fine lines and may e.g. contain the company logo.

1. Item with forgery-proof printing having at least one surface area (12) with a first image (14) printed on it,
characterized in that,
in order to increase the degree of proof against forgery, a second image (16) of a transparent matt lacquer and of greater resolution than that of the first printed image (14) is printed over the first printed image (14).

2. Item according to claim 1, characterized in that the matt lacquer is color-less.

3. Item according to claim 1 characterized in that the second printed image (16) exhibits a complex printed pattern.

4. Process for increasing the degree of proof against forgery of a surface (12) of an item on which surface a first image (14) has been printed,
characterized in that,
a second image (16) of a transparent matt lacquer and of greater resolution than that of the first printed image (14) is printed over the first image (14).

5. Process according to claim 4, characterized in that the second image (16) is printed using a transparent matt lacquer.

6. Process according to claim 4, characterized in that the second image (16) is a complex printed image.

7. Process according to claim 4, characterized in that the second image (16) is printed using the intaglio printing method with intaglio cylinders having a very high degree of resolution.

8. Process according to one claim 4, characterized in that the second image is printed using the offset printing method.

9. Use of an item according to claim 1 in the form of a packaging, a packing material, an aid to packing, bonds, an entry ticket or such documents with forgery-proof surface area.

10. Item according to claim 2, characterized in that the second printed image (16) exhibits a complex printed pattern.

11. Process according to claim 5, characterized in that the second image (16) is a complex printed image.

12. Process according to claim 5, characterized in that the second image (16) is printed using the intaglio printing method with intaglio cylinders having a very high degree of resolution.

13. Process according to claim 6, characterized in that the second image (16) is printed using the intaglio printing method with intaglio cylinders having a very high degree of resolution.

14. Process according to claim 5, characterized in that the second image is printed using the offset printing method.

15. Process according to claim 6, characterized in that the second image is printed using the offset printing method.

16. Process according to claim 11, characterized in that the second image is printed using the offset printing method.

17. Use of an item according to claim 2 in the form of a packaging, a packing material, an aid to packing, bonds, an entry ticket or such documents with forgery-proof surface area.

18. Use of an item according to claim 3 in the form of a packaging, a packing material, an aid to packing, bonds, an entry ticket or such documents with forgery-proof surface area.

19. Use of an item according to claim 10 in the form of a packaging, a packing material, an aid to packing, bonds, an entry ticket or such documents with forgery-proof surface area.
